(19) United States
(12) Patent Application Publication
(10) Pub. No.: US 2015/0287493 A1
(43) Pub. Date: Oct. 8, 2015

(54) ELECTRICALLY CONDUCTIVE POLYAMIDE MOULDING MATERIALS

(71) Applicant: EMS-PATENT AG, Domat/Ems (CH)

(72) Inventors: Etienne AEPLI, Domat/Ems (CH); Pierre DUEBON, Chur (CH)

(73) Assignee: EMS-PATENT AG, Domat/Ems (CH)

(21) Appl. No.: 14/680,608

(22) Filed: Apr. 7, 2015

(30) Foreign Application Priority Data
Apr. 8, 2014 (CH) CH 00543/14
Feb. 18, 2015 (EP) 15155617.2

(51) Int. Cl. H01B 1/18

(52) U.S. Cl. CPC H01B 1/18

(57) ABSTRACT

A polyamide molding material with the following composition is proposed:
(a) 20 to 85% by weight of at least one semi-crystalline polyamide;
(b) 4 to 18% by weight of carbon fibers with a fiber diameter in the range of 2 to 10 μm;
(c) 10 to 60% by weight of at least one particulate mineral or saline filler;
(d) 3 to 30% by weight of at least one amorphous polymer with a glass transition temperature of at least 45° C. determined according to ISO 11357;
(e) 0 to 20% by weight of carbon black;
(f) 0 to 20% by weight of at least one further additive and/or addition agent;
   wherein the components (a) to (f) add up in total to 100% by weight.

### CROSS-REFERENCE TO RELATED APPLICATIONS

The present application claims priority under 35 U.S.C. §119(a) of Switzerland Patent Application No. CH 00543/14 filed Apr. 8, 2014 and of European Application No. EP 15 155 617.2 filed Feb. 18, 2015, the disclosures of which are expressly incorporated by reference herein in their entireties.

### BACKGROUND OF THE INVENTION

1. Field of the Invention

The present invention relates to electrically conductive polyamide molding materials, molded bodies made from said molding materials, and the use of particulate fillers for increasing the electrical conductivity of polyamide molding materials containing carbon fibers.

2. Discussion of Background Information

In addition to their good thermal and electric conductivity, carbon fibers are especially characterized by their low weight. Carbon fibers usually have a diameter in the range of 2 to 10 μm and are mostly produced on the basis of polyacrylonitrile (PAN). Carbon fiber reinforced plastic materials (also known under the abbreviation CFRP) are used in lightweight construction in aviation and astronautics or for sports appliances for example due to the aforementioned low weight and their outstanding mechanical properties.

As a result of their good electrical conductivity, CFRPs are suitable among other things for applications in which antistatic properties play a role. CFRPs can also be used advantageously in electrostatic painting. In the latter application, high demands are also placed on the surface quality of the molded parts. As a result of the high price of carbon fibers, there is a desire to reach the electrostatic conductivity required for the respective application with the lowest possible fraction of carbon fibers.

It is the object of WO 2010/128013 A1 to provide electrically conductive polyamide molding materials whose electric conductivity is virtually independent of absorption of water. A molding material of a thermoplastic polyamide, a polymerizate of propylene, a special compatibilizer and a conductivity additive from the range of carbon fibers and carbon nanotubes are disclosed as the solution for the object of the invention. It is the object of the polymerizate of propylene to reduce the absorption of water of the molding material. The compatibilizer produces the compatibility between polyolefin and polyamide.

US 2003/0134963 A1 relates to an electrically conductive resin composition, which comprises a polyamide, a polyphenylene ether (PPE), an impact modifier and an electrically conductive filler. Conductive carbon black, carbon nanotubes and carbon nanofibers are disclosed as electrically conductive fillers. Carbon nanotubes are processed in the examples in addition to a special conductive carbon black.

US 2006/0124906 A1 discloses a composition based on polyamide which comprises electrically conductive fillers. These molding materials are suitable among other things for electrostatic painting processes. Carbon fibers are disclosed among other things as electrically conductive fillers. A special conductive carbon black is used in the examples.

EP 0 877 049 A1 describes an electrostatically coated polyamide material. A composition is disclosed for the polyamide material which contains 25-90% by weight of polyamide, 5-50% by weight of a mineral filler and 0.1-25% by weight of carbon black and/or carbon fiber. The addition of the mineral filler ensures a constant charge distribution in the material, leading to an improved, more constant adhesion of the paint. In addition to the preferred spherical ceramic material, Kaolin, calcium carbonate, calcium and barium sulphate as well as clay and mica are proposed as mineral fillers, among others.

EP 2 463 341 A1 describes an electrically conductive plastic molding material which contains a polyamide, a polyphenylene ether and a fine carbon fiber. The molding material can contain additional components such as barium sulphate, calcium carbonate, clay minerals, talcum etc. The fine carbon fibers described herein do not concern cylindrical structures, but agglomerates of temple-bell-shaped carbon crystals with overlapping lattice planes, which crystals are stacked on top of each other in the axial direction. The conductivity mechanism of this longitudinally agglomerated crystal structure cannot be compared to other carbon fibrils or regular carbon fibers, but the electrical conduction occurs via the surface and the tunnel effect in the region of the overlapping ends. The fine carbon fibers with the special structure of EP 2 463 341 A1 have an outside diameter of 5 to 40 nm.

2006/0122310 A1 describes conductive polyarylene polyamide blends, which are suitable for electrostatic painting and show a high surface quality. Clay together with Kaolin and aluminum silicates are preferred additives. The conductivity agents are selected from carbon black and/or carbon fibrils. These carbon fibrils concern carbon nanotubes with an outside diameter of up to 75 nm. Their share in the mass is 0.1 to 3% by weight.

WO 01/36536 A1 concerns conductive polyphenylene ether polyamide blends with carbon fibrils. The same carbon fibrils (carbon nanotubes) as in US 2006/0122310 A1 are used, and Hyperion is also mentioned as the source. The content of the carbon fibrils in the molding material is indicated with 0.4 to 3.0% by weight (percent by weight).

### SUMMARY OF THE EMBODIMENTS

Embodiments of the present invention provide carbon-fiber reinforced polyamide molding materials with a carbon fiber diameter in the usual range, which show high electrical conductivity respectively low electrical resistance. Further embodiments provide polyamide molding materials from which polyamide molded bodies with smooth surface (high gloss) can be produced. Furthermore, molded bodies from the molding materials in accordance with the invention shall have very good mechanical properties.

According to embodiments, the present invention includes a polyamide molding material with the following composition:
(a) 20 to 85% by weight of at least one semi-crystalline polyamide;
(b) 4 to 18% by weight of carbon fibers with a fiber diameter in the range of 2 to 10 μm,
(c) 10 to 60% by weight of at least one particulate mineral or saline filler;
(d) 3 to 30% by weight of at least one amorphous polymer with a glass transition temperature of at least 45° C. determined according to ISO 11357;
(e) 0 to 20% by weight of carbon black;
(f) 0 to 20% by weight of at least one further additive and/or addition agent,
   wherein the components (a) to (f) add up in total to 100% by weight.

Preferred embodiments of the polyamide molding material in accordance with the invention are provided in the dependent claims. Polyamide molded bodies are further claimed, which consist at least in sections of a polyamide molding material in accordance with the invention. The use of particulate mineral or saline fillers in carbon-fiber-containing polyamide molding materials is further claimed.

Notice shall be taken at this point that the term “polyamide” (abbreviated PA) is a generic term which comprises homopolyamides and copolyamides as well as mixtures thereof The notations and abbreviations for polyamides and their monomers are determined in the ISO standard 1874-1:1992(E).

The at least one semi-crystalline polyamide (a) is preferably an aliphatic, especially a linear-aliphatic, or a semi-aromatic polyamide.

Especially preferred semi-crystalline polyamides (a) are selected from the group consisting of PA 46, PA 6, PA 66, PA 11, PA 12, PA 610, PA 1212, PA 1010, PA 10/11, PA 10/12, PA 11/12, PA 6/10, PA 6/12, PA 6/9, PA 8/10, PA 612, PA 614, PA 66/6, PA 4T/4I, PA 4T/6I, PA 5T/5I, PA 6T/6I, PA 6T/6I/6, PA 6T/66, PA 6T/610, PA 10T/106, PA 6T/612, PA 6T/10T, PA 6T/10I, PA 9T, PA 10T, PA 12T, PA 10T/10I, PA10T/12, PA10T/11, PA 6T/9T, PA 6T/12T, PA 6T/10T/6I, PA 6T/6I/6, PA 6T/6I/12, PA 10T/612, PA 10T/610, and/or mixtures, blends or alloys of said polyamides, wherein PA 66 and PA 612 are especially preferred.

In a preferred embodiment, the at least one semi-crystalline polyamide (a) is contained in the polyamide molding material with 25 to 50% by weight, especially preferably 27 to 45% by weight, and more preferably 30 to 40% by weight.

The polyamide molding material in accordance with the invention contains 4 to 18% by weight and preferably 5 to 16% by weight of carbon fibers (b).

If higher quantities of the carbon fibers are used, the molding material becomes very expensive and the surface quality can additionally deteriorate. Furthermore, materials become brittle at higher carbon fiber fractions without further improving the electrical properties. In the case of lower quantities of carbon fibers however, the electrical and mechanical properties of the molding material will become poor.

Furthermore, a polyamide molding material in accordance with the invention is preferred if the employed carbon fibers (b) have an average length in the range of between 100 and 15000 μm. After compounding, the fiber length in the granulate is usually between 100 and 500 μm and usually between 100 and 400 μm in the completed component. If pultrusion methods are applied, the fiber length in the granulate corresponds to the length of the granulate. The diameter of the carbon fibers lies in the range of 2 to 10 μm and preferably in the range of 3 to 9 μm. The carbon fibers (b) preferably have a cylindrical shape.

It is possible to use both coated and also uncoated carbon fibers. It is possible to use a single type of carbon fibers or also mixtures of two or more types of carbon fibers.

In a special embodiment, the polyamide molding material is completely free from fibrous reinforcing materials other than the carbon fibers.

The particulate mineral or saline fillers (c) are preferably selected from the group consisting of calcium carbonate, magnesium carbonate, dolomite, calcium hydroxide, magnesium hydroxide, calcium sulphate, barium sulphate, barite, calcium silicates, aluminum silicates, kaolin, chalk, mica, layered silicates, talcum, clay, and/or mixtures of said fillers, wherein calcium carbonate is especially preferred.

The average diameter of the particulate mineral or saline fillers (c) usually lies in the range of 0.01 to 100 μm, preferably in the range of 0.05 to 25 μm, and especially preferably in the range of 0.06 to 5 μm.

The particulate mineral or saline fillers (c) can also have an influence on the surface gloss of the molded bodies produced from the polyamide molding material in accordance with the invention, depending on the structure or particle size.

The particulate mineral or saline filler (c) is preferably contained in the polyamide molding material with 15 to 55% by weight, especially preferably with 20 to 50% by weight, and more preferably with 35 to 45% by weight. If higher quantities of the filler (c) are used, the mechanical properties of the molding material will become poor and respective molded parts will become very brittle. In the case of lower quantities however, the electrical properties of the molding material will deteriorate.

The at least one amorphous polymer (d) is preferably selected from the group consisting of amorphous polyamides and polyphenylene ethers.

The at least one amorphous polymer (d) is especially preferably selected from the group consisting of PA 6I, PA 10I, copolyamides 6I/6T with a mol ratio of isophthalic acid to terephthalic acid of between 1:0 and 3:2, copolyamides 10I/10T with a mol ratio of isophthalic acid to terephthalic acid of between 1:0 and 3:2, polyphenylene ethers, especially poly(2,6-diethyl-1,4-phenylene) ether, poly(2-methyl-6-ethyl-1,4-phenylene) ether, poly(2-methyl-6-propyl-1,4-phenylene) ether, poly(2,6-dipropyl-1,4-phenylene) ether, poly(2-ethyl-6-propyl-1,4-phenylene) ether, polyphenylene ether copolymers which contain 2,3,6-trimethyl phenol, grafted variants (preferably grafted with maleic anhydride, abbreviated MAH) of the aforementioned polyphenylene ethers, and further mixtures of the aforementioned polyphenylene ethers, and/or mixtures of the aforementioned amorphous polymers, wherein a copolyamide 6I/6T with a mol ratio of isophthalic acid to terephthalic acid of 2:1 is especially preferred. The expression “mixtures” in connection with the component (d) means that in such a case two or more amorphous polymers (d) are contained in the polyamide molding material in accordance with the invention. They can be added separately to a compounding machine in the production of the polyamide molding material and need not be premixed.

In an especially preferred embodiment, the at least one amorphous polymer (d) is a mixture of an amorphous polyamide with a polyphenylene ether.

Polyphenylene ethers can be added either alone or as a blend with another polymer to a compounding machine for producing the polyamide molding material in accordance with the invention. In a preferred variant, the blend is a mixture with a polyamide. The polyamide of the blend is a semi-crystalline polyamide in an especially preferred manner, and more preferably of the same type as the component (a) of the polyamide molding material in accordance with the invention.

Furthermore, the at least one amorphous polymer (d) has a glass transition temperature according to ISO 11357 of preferably 50° C. to 280° C., especially preferably 60° C. to 250° C., and more preferably 75° C. to 220° C.

The at least one amorphous polymer (d) is preferably contained in the polyamide molding material with 5 to 27% by weight, especially preferably 8 to 20% by weight, and more preferably 7 to 17% by weight.

If the at least one amorphous polymer (d) comprises polyphenylene ether, the polyamide molding material preferably contains 5 to 9% by weight of polyphenylene ether. The polyamide molding material is free from polyphenylene ether in other preferred embodiments.

In a further preferred embodiment, the polyamide molding material in accordance with the invention contains carbon black (e) in a fraction of 1 to 15% by weight, especially preferably 2 to 12% by weight, and more preferably 3 to 8% by weight. Preferred carbon blacks are selected from commercially available trade products such as Ketjenblack®, Ensaco®, BASIONICS VS03, BASIONICS LQ01, Vulcan P, Vulcan XC-72, Black Pearls 2000, etc. It is possible to use one single type of carbon black, or it is also possible to use mixtures of two or more types of carbon black.

The polyamide molding material in accordance with the invention contains in a preferred embodiment at least one further additive and/or at least one further addition agent (f) selected from the group consisting of UV absorbers, UV stabilizers, heat stabilizers, hydrolysis stabilizers, cross-linking activation agents, cross-linking agents, flame retardants, coloring agents, adhesion-promoting agents, compatibilizers, lubricants, glass fibers, auxiliary lubricants and mold release agents, inorganic pigments, organic pigments, IR absorbers, antistatic agents, anti-blocking agents, nucleation agents, crystallization accelerants, crystallization retarders, chain-lengthening additives, optical brighteners, photochromic additives, impact modifiers, wherein maleic-anhydride-modified olefin copolymers and/or mixtures thereof are preferred as impact modifiers.

Examples for preferred impact modifiers are the following ones that are commercially available:
TAFMER MC201: g-MAH (−0.6%) blend of 67% EP copolymer (20 mol % propylene)+33% EB copolymer (15 mol-% butene-1); Mitsui Chemicals, Japan.
TAFMER MH5010: g-MAH (−0.6%) ethylene butylene copolymer; Mitsui.
TAFMER MH7010: g-MAH (−0.7%) ethylene butylene copolymer; Mitsui.
TAFMER MH7020: g-MAH (−0.7%) EP copolymer, Mitsui.
EXXELOR VA1801: g-MAH (−0.7%) EP copolymer; Exxon Mobile Chemical, US.
EXXELOR VA1803: g-MAH (0.5-0.9%) EP copolymer, amorphous, Exxon.
EXXELOR VA1810: g-MAH (−0.5%) EP copolymer, Exxon.
EXXELOR MDEX 94-1 1: g-MAH (0.7%) EPDM, Exxon.
FUSABOND MN493D: g-MAH (−0.5%) ethylene octene copolymer, DuPont, US.
FUSABOND A EB560D (g-MAH) ethylene-n-butyl acrylate copolymer, DuPont.
ELVALOY, DuPont.
Lotader AX 8840, Arkema, FR.
Bondyram, IL.

The polyamide molding material is free from lubricants and/or free from compatibilizers in preferred embodiments.

The further additives and/or addition agents (f) are contained in the polyamide molding material preferably with 0.1 to 15% by weight, especially preferably with 0.2 to 10% by weight, and more preferably with 0.25 to 5% by weight.

A plastic molding material in accordance with the invention preferably has a specific surface resistance of 1*10⁻¹ to 1*10⁴, especially preferably 1 to 1*10³, and more preferably 1*10¹ to 9*10² ohms. The specific volume resistance of a plastic molding material in accordance with the invention is preferably 1*10⁻² to 1*10³, especially preferably 1*10⁻¹ to 1*10², more preferably 1 to 5*10¹ ohm*m.

Preferred gloss values are at least 80, and especially preferably at least 90, measured according to the method disclosed below. The inventors were surprised to find that an important influential factor in the achievement of such high gloss values is the addition of an amorphous polymer (d) with a glass transition temperature of at least 45° C. to a semi-crystalline polyamide.

Preferred mechanical properties relate to minimum values for impact strength (at least 28 kJ/m²), notch impact strength (at least 4.8 kJ/m²), elongation at tear (at least 1.4%), tensile modulus (at least 5000 MPa) and tear strength (at least 70 MPa).

An especially preferred molding material has the following composition:
(a) 32 to 58% by weight of at least one semi-crystalline aliphatic polyamide, especially PA 66 or PA 612;
(b) 4 to 17% by weight of carbon fibers with a fiber diameter in the range of 2 to 10 μm;
(c) 30 to 45% by weight of at least one particulate mineral or saline filler;
(d) 8 to 20% by weight of at least one amorphous polymer with a glass transition temperature of at least 45° C. determined according to ISO 11357;
(e) 0% by weight of carbon black;
(f) 0 to 5% by weight of at least one further additive and/or addition agent,
   wherein the components (a) to (f) add up in total to 100% by weight.

Polyamide molded bodies are also provided in accordance with the invention, which can be produced at least in sections from a polyamide molding material as described above, e.g. by injection molding. These polyamide molded bodies are preferably provided in form of components which require electrical conductivity, for interior and exterior parts in the automotive sector and in the region of other means of transport, preferably for filler cap covers, in the electric and electronic sector, especially for parts of the housing or housing component for portable electronic devices, domestic appliances, domestic machines, devices and apparatuses for telecommunications and consumer electronics, preferably mobile phones, interior and exterior parts with preferably supporting mechanical function with electrical conductivity in the areas of electricity, furniture, sports, mechanical engineering, sanitation and hygiene, medicine, energy and drive technology.

Embodiments further relate to the use of particulate mineral or saline fillers for reducing the specific surface resistance and/or the specific volume resistance of carbon-fiber-containing polyamide molding materials with a carbon fiber diameter in the range of 2 to 10 μm.

### DETAILED DESCRIPTION OF THE EMBODIMENTS

The present invention will be explained below in closer detail by reference to the following examples which illustrate the invention but do not limit the scope of the invention.

The materials mentioned in Table 1 were used in the examples and comparison examples.

TABLE 1
Employed materials.

| | | | | H₂O |
|---|---|---|---|---|
| | | | | content |
| | | | Rel. | [% |
| Substance | Trade name | Manufacturer | viscosity | by weight] |
| PA 66 A | RADIPOL A40 | Radici (IT) | 2.503^{a)} | 0.03 |
| PA 66 B | RADIPOL A45 | Radici (IT) | 2.736^{a)} | 0.025 |
| PA 612 | Grivory XE 1291 | EMS-GRIVORY | 1.820^{a)} | 0.02 |
| | | (CH) | | |
| PA 6I/6T (2:1) | GRIVORY G21 | EMS-GRIVORY | 1.530^{b)} | 0.03 |
| (amorphous, Tg = | | (CH) | | |
| 125° C.^{c)}) | | | | |
| Calcium carbonate | Millicarb | Omya (DE) | — | — |
| (mean particle size | | | | |
| d50, 3 μm) | | | | |
| Carbon fiber | CF TENAX E-HT | Toho Tenax (DE) | — | — |
| | C604 6 MM | | | |
| Stabilizer | Irganox 1098 | BASF (CH) | — | — |
| Carbon black | Ketjenblack EC-600 | Akzo Nobel (NL) | — | — |
| | JD | | | |
| Impact modifier 1 | Bondyram 7103 | Polyram (IL) | — | — |
| Impact modifier 2 | Bondyram 7107 | Polyram (IL) | — | — |
| Impact modifier 3 | Bondyram TL4108N | Polyram (IL) | — | — |
| Polyphenylene ether | Bondyram 6008 | Polyram (IL) | — | — |
| (amorphous, Tg = | (Blend of 49% by | | | |
| 200° C.^{c)}) | weight of PPE, 49% | | | |
| | by weight of PA 66 | | | |
| | and 2% by weight of | | | |
| | MAH) | | | |

^{a)}Determined according to ISO 307 (1.0 g of polyamide dissolved in 100 mL of H₂SO₄), calculation of relative viscosity (RV) according to RV = t/t₀ based on section 11 of the standard.
^{b)}Determined according to ISO 307 (0.5 g of polyamide dissolved in 100 mL of m-cresol), calculation of relative viscosity (RV) according to RV = t/t₀ based on section 11 of the standard.
^{c)}Determined according to ISO 11357.

### Compounding

In general, the components are mixed in the polymer melt (compounded) on conventional compounding machines such as single-shaft or double-shaft extruders or screw mixers for the production of the plastic molding material. The components are dosed individually to the feed or supplied in form of a dryblend. If addition agents (additives) are used, they can be introduced directly or in form of a master batch. In the case of a dryblend production, the dried polymer granulates and the additives are mixed. The mixing can occur under a dried protective gas for avoiding the absorption of humidity.

Compounding is carried out at set extruder cylinder temperatures of 230° C. to 350° C. for example. A vacuum can be applied before the nozzle or it can be atmospherically degassed. The melt is discharged in stranded shape to a water bath and granulated. Underwater granulation or hot die-face cutting is preferably used for granulation. The plastic molding material thus preferably obtained in granular form is subsequently dried and can subsequently be further processed into shaped bodies.

The molding materials for the examples B1 to B8 in accordance with the invention and for the comparative examples VB1 to VB6 were produced on a two-shaft extruder of “Werner and Pfleiderer” Co. The mass fractions of the starting materials stated in Table 2 in percent by weight (% by weight) relating to 100% by weight of the entire molding material were compounded in the two-shaft extruder. Sample bodies were injection-molded from the obtained granulate, from which the properties stated in Table 3 were determined.

### Standards for Determining the Mechanical Data and the Electrical Conductivity Properties

The mechanical data and conductivity properties stated in Table 3 (wherein the latter is expressed by the electric resistance which acts inversely proportional to the conductivity) were determined according to the following standards:

### Tensile Modulus

ISO 527 with a tensile velocity of 1 mm/min

ISO tension rod, standard: ISO 3167, type A, 170×20/10×4 mm, temperature 23° C.

### Tear Strength and Elongation at Tear

ISO 527 with a tensile velocity of 5 mm/min

ISO tension rod, standard: ISO 3167, type A, 170×20/10×4 mm, temperature 23° C.

### Charpy Impact Strength and Charpy Notched Bar Impact Strength

ISO 179-2/1 eU (Charpy impact strength)

ISO tension rod, standard: ISO 179-1, type 1, 80×10×4 mm, temperature 23° C.

### Specific (Electrical) Resistivity

(also known as specific volume resistance, in [ohm*m])

IEC 60093

Plates 100*100*2 mm, contact with conductive silver

### Specific (Electrical) Surface Resistance

(also known as Ω square due to electrode arrangement, in [ohm])

IEC 60093

Plates 100*100*2 mm, contact with conductive silver

### Gloss Values

Gloss was determined on plates of the dimension 80×80×1 mm with a device of type Minolta Multi Gloss 268 under an angle of 85° and at a temperature of 23° C. according to ISO 2813. The gloss value is stated in dimensionless gloss units (GU, gloss units).

### Tests

The compositions of the molding materials of the performed tests (B=examples in accordance with the invention, and VB=comparative examples) are shown in the following Table 2.

The results of the measurements are summarized in Table 3.

TABLE 2
Compositions (in percent by weight).

| Examples | B1 | B2 | B3 | B4 | B5 | B6 | B7 |
|---|---|---|---|---|---|---|---|
| PA 66 A | — | — | 37.25 | 26.07 | 31.0 | 31.0 | 31.0 |
| PA 66 B | — | 37.25 | — | — | — | — | — |
| PA 612 | 35.75 | — | — | — | — | — | — |
| PA 6I/6T (2:1) | 14.0 | 12.5 | 12.5 | 8.75 | 10.4 | 10.4 | 10.4 |
| Calcium | 35.0 | 35.0 | 35.0 | 35.0 | 40.0 | 40.0 | 40.0 |
| carbonate | | | | | | | |
| Carbon fiber | 15.0 | 15.0 | 15.0 | 15.0 | 5.0 | 5.0 | 5.0 |
| Stabilizer | 0.25 | 0.25 | 0.25 | 0.25 | 0.25 | 0.25 | 0.25 |
| Carbon black | — | — | — | — | 3.0 | 3.0 | 3.0 |
| Impact | — | — | — | — | 10.35 | — | — |
| modifier 1 | | | | | | | |
| Impact | — | — | — | — | — | 10.35 | — |
| modifier 2 | | | | | | | |
| Impact | — | — | — | — | — | — | 10.35 |
| modifier 3 | | | | | | | |
| Polyphenylene | — | — | — | 14.93 | — | — | — |
| ether blend | | | | (7.32 | | | |
| | | | | PPE) | | | |

| Examples | B8 | VB1 | VB2 | VB3 | VB4 | VB5 | VB6 |
|---|---|---|---|---|---|---|---|
| PA 66 A | 34.82 | 31.0 | — | 37.3 | 63.5 | 52.275 | 44.75 |
| PA 6I/6T (2:1) | — | 10.4 | 34.82 | 12.52 | 21.25 | 17.545 | — |
| Calcium | 35.0 | 40.0 | 35.0 | 35.0 | — | — | 35.0 |
| carbonate | | | | | | | |
| Carbon fiber | 15.0 | — | 15.0 | — | 15.0 | 15.0 | 15.0 |
| Stabilizer | 0.25 | 0.25 | 0.25 | 0.25 | 0.25 | 0.25 | 0.25 |
| Carbon black | — | 8.0 | — | — | — | — | — |
| Impact | — | 10.35 | — | — | — | — | 5 |
| modifier 1 | | | | | | | |
| Polyphenylene | 14.93 | — | 14.93 | 14.93 | — | 14.93 | — |
| ether blend | (7.32 | | (7.32 | (7.32 | | (7.32 | |
| | PPE) | | PPE) | PPE) | | PPE) | |

TABLE 3
Results of the measurements.

| Examples | B1 | B2 | B3 | B4 | B5 | B6 | B7 |
|---|---|---|---|---|---|---|---|
| Specific volume | 3.9*10¹ | 2.7 | 4.5 | 4.0 | 1.8*10¹ | 2.3*10¹ | 2.7*10¹ |
| resistance | | | | | | | |
| [ohm*m] | | | | | | | |
| Specific surface | 7.5*10² | 1.2*10² | 1.8*10² | 1.6*10² | 2.7*10² | 3.8*10² | 6.6*10² |
| resistance [ohm] | | | | | | | |
| Gloss 85° | 93.3 | 94.5 | 84.2 | 93.5 | 89.7 | 90.9 | 80.9 |
| Impact strength | 39.7 | 47.9 | 50.4 | 41.6 | 39.4 | 36.5 | 29.2 |
| 23° C., dry [kJ/m²] | | | | | | | |
| Notch impact | 5.1 | 6.5 | 6.5 | 6.6 | 7.0 | 6.9 | 5.0 |
| strength, 23° C., dry | | | | | | | |
| [kJ/m²] | | | | | | | |
| Elongation at tear | 1.6 | 1.8 | 1.9 | 1.5 | 3.2 | 3.3 | 2.4 |
| [%] | | | | | | | |
| Tensile modulus | 19500 | 18200 | 18600 | 18500 | 6000 | 5800 | 7100 |
| [MPa] | | | | | | | |
| Tear strength | 204 | 205 | 210 | 197 | 75 | 74 | 84 |
| [MPa] | | | | | | | |

| Examples | B8 | VB1 | VB2 | VB3 | VB4 | VB5 | VB6 |
|---|---|---|---|---|---|---|---|
| Specific volume | 2.8 | 2.5*10¹ | 1.1 | 8.3*10⁸ | 1.6*10⁴ | 4.1*10⁴ | 9.5*10⁻¹ |
| resistance | | | | | | | |
| [ohm*m] | | | | | | | |
| Specific surface | 9.2*10¹ | 4.2*10² | 5.5*10¹ | 3.5*10¹⁰ | 1.3*10⁵ | 2.4*10⁶ | 5.0*10¹ |
| resistance [ohm] | | | | | | | |
| Gloss 85° | 92.6 | 48.3 | 79.8 | 90.7 | 79.1 | 80.7 | 67.5 |
| Impact strength | 38.9 | 5 | 23.6 | 48.1 | 38.0 | 38.9 | 49.5 |
| 23° C., dry [kJ/m²] | | | | | | | |
| Notch impact | 6.4 | 1.1 | 5.1 | 4.6 | 5.1 | 4.7 | 6.4 |
| strength, 23° C., dry | | | | | | | |
| [kJ/m²] | | | | | | | |
| Elongation at tear | 1.5 | 0.3 | 1.3 | 1.6 | 3.9 | 4.1 | 1.0 |
| [%] | | | | | | | |
| Tensile modulus | 18900 | 250 | 19000 | 4400 | 11600 | 11100 | 16500 |
| [MPa] | | | | | | | |
| Tear strength | 195 | 17 | 187 | 62 | 170 | 160 | 129 |
| [MPa] | | | | | | | |

The examples of the embodiments of the invention show that polyamide molding materials are obtained by a combination of the features in accordance with the invention which, in addition to good mechanical properties, surprisingly also show very good electrical conductivity and very good surface properties. Gloss is used as a measure for the surface properties. Comparative example VB1, which merely contains carbon black instead of the carbon fibers in accordance with the invention, shows a very low gloss value and very bad mechanical properties. The gloss and the impact strength are impaired by leaving out the semi-crystalline component as in the comparative example VB2. Comparative example VB6 shows that the gloss will deteriorate distinctly if no amorphous polymer is contained in the molding material. The comparative examples VB3 to VB5 demonstrate impressively that both the carbon fiber and also the particulate filler are necessary in order to achieve very good electrical conductivity, or that this is not achieved when one of these two components is missing. The measured specific resistances, which act inversely to the electrical conductivity, are higher by a factor of 10³ to 10⁸ in VB3, VB4 and VB5 than in the examples in accordance with the invention. Example B4 is an example for a preferred embodiment which contains both an amorphous polyamide and also a polyphenylene ether, i.e. in which the at least one amorphous polymer (d) represents a mixture of an amorphous polyamide with a polyphenylene ether. The examples B5 to B7 show that the carbon fiber fraction can be reduced when carbon black is added to the molding material. Partly better conductivities (lower resistances) are obtained on the other hand by 5% by weight of carbon fibers and 3% by weight of carbon black than by 8% by weight of carbon black (in comparison with VB1). The example B8 shows that very good gloss values are also obtained when the molding material, as an amorphous polymer (d), contains an amorphous non-polyamide such as a polyphenylene ether instead of an amorphous polyamide.

The present invention can thus provide advantageous polyamide molding materials which in a manner unexpected to the person skilled in the art simultaneously fulfil the requirements of high electrical conductivity, smooth surface (high gloss) and very good mechanical properties. Shaped bodies made from such molding materials are of high quality, have a pleasant appearance and are also highly suitable among other things for electrostatic powder coating and electro-dip painting (KTL process). It was not obvious to a person skilled in the art with respect to the prior art that this can be achieved in accordance with the invention by carbon fibers in the conventional diameter range (instead of carbon nanotubes) and preferably also without a polyphenylene ether component.

What is claimed:

1. A polyamide molding material, having the following composition:
(a) 20 to 85% by weight of at least one semi-crystalline polyamide;
(b) 4 to 18% by weight of carbon fibers with a fiber diameter in the range of 2 to 10 μm;
(c) 10 to 60% by weight of at least one particulate mineral or saline filler;
(d) 3 to 30% by weight of at least one amorphous polymer with a glass transition temperature of at least 45° C. determined according to ISO 11357;
(e) 0 to 20% by weight of carbon black;
(f) 0 to 20% by weight of at least one further additive and/or addition agent;
wherein the components (a) to (f) add up in total to 100% by weight.

2. A polyamide molding material according to claim 1, characterized in that the semi-crystalline polyamide (a) is an aliphatic or a semi-aromatic polyamide.

3. A polyamide molding material according to claim 1, characterized in that the semi-crystalline polyamide (a) is selected from the group consisting of PA 46, PA 6, PA 66, PA 11, PA 12, PA 610, PA 1212, PA 1010, PA 10/11, PA 10/12, PA 11/12, PA 6/10, PA 6/12, PA 6/9, PA 8/10, PA 612, PA 614, PA 66/6, PA 4T/4I, PA 4T/6I, PA 5T/5I, PA 6T/6I, PA 6T/6I/6, PA 6T/66, PA 6T/610, PA 10T/106, PA 6T/612, PA 6T/10T, PA 6T/10I, PA 9T, PA 10T, PA 12T, PA 10T/10I, PA10T/12, PA10T/11, PA 6T/9T, PA 6T/12T, PA 6T/10T/6I, PA 6T/6I/6, PA 6T/6I/12, PA 10T/612, PA 10T/610, and/or mixtures, blends or alloys of said polyamides, wherein PA 66 and PA 612 are preferred.

4. A polyamide molding material according to claim 1, characterized in that the at least one semi-crystalline polyamide (a) is contained in the polyamide molding material with 25 to 50% by weight, preferably 27 to 45% by weight, and more preferably 30 to 40% by weight.

5. A polyamide molding material according to claim 1, characterized in that the carbon fibers (b) are contained in the polyamide molding material with 5 to 16% by weight.

6. A polyamide molding material according to claim 1, characterized in that the particulate mineral or saline filler (c) is selected from the group consisting of calcium carbonate, magnesium carbonate, dolomite, calcium hydroxide, magnesium hydroxide, calcium sulphate, barium sulphate, barite, calcium silicates, aluminum silicates, kaolin, chalk, mica, layered silicates, talcum, clay, and/or mixtures of said fillers, wherein calcium carbonate is preferred.

7. A polyamide molding material according to claim 1, characterized in that the at least one particulate mineral or saline filler (c) is contained in the polyamide molding material with 15 to 55% by weight, preferably 20 to 50% by weight, and more preferably 35 to 45% by weight.

8. A polyamide molding material according to claim 1, characterized in that the at least one amorphous polymer (d) is selected from the group consisting of PA 6I, PA 10I, copolyamides 6I/6T with a mol ratio of isophthalic acid to terephthalic acid of between 1:0 and 3:2, copolyamides 10I/10T with a mol ratio of isophthalic acid to terephthalic acid of between 1:0 and 3:2, polyphenylene ethers, especially poly(2,6-diethyl-1,4-phenylene) ether, poly(2-methyl-6-ethyl-1,4-phenylene) ether, poly(2-methyl-6-propyl-1,4-phenylene) ether, poly(2,6-dipropyl-1,4-phenylene) ether, poly(2-ethyl-6-propyl-1,4-phenylene) ether, polyphenylene ether copolymers which contain 2,3,6-trimethyl phenol, grafted variants of the aforementioned polyphenylene ethers, further mixtures of the aforementioned polyphenylene ethers, and/or mixtures of the aforementioned amorphous polymers, wherein a copolyamide 6I/6T with a mol ratio of isophthalic acid to terephthalic acid of 2:1 is preferred.

9. A polyamide molding material according to claim 1, characterized in that the at least one amorphous polymer (d) has a glass transition temperature determined according to ISO 11357 of 50° C. to 280° C., preferably 60° C. to 250° C., and more preferably 75° C. to 220° C.

10. A polyamide molding material according to claim 1, characterized in that the at least one amorphous polymer (d) is contained in the polyamide molding material with 5 to 27% by weight, preferably 8 to 20% by weight, and more preferably 7 to 17% by weight.

11. A polyamide molding material according to claim 1, characterized in that the at least one amorphous polymer (d) comprises polyphenylene ether, wherein the polyamide molding material contains 5 to 9% by weight of polyphenylene ether.

12. A polyamide molding material according to claim 1, characterized in that the carbon black (e) is contained in the polyamide molding material with 1 to 15% by weight, preferably 2 to 12% by weight, and more preferably 3 to 8% by weight.

13. A polyamide molding material according to claim 1, characterized in that the at least one further additive and/or the at least one further addition agent (f) is selected from the group consisting of UV absorbers, UV stabilizers, heat stabilizers, hydrolysis stabilizers, cross-linking activation agents, cross-linking agents, flame retardants, coloring agents, adhesion-promoting agents, compatibilizers, lubricants, glass fibers, auxiliary lubricants and mold release agents, inorganic pigments, organic pigments, IR absorbers, antistatic agents, anti-blocking agents, nucleation agents, crystallization accelerants, crystallization retarders, chain-lengthening additives, optical brighteners, photochromic additives, impact modifiers, wherein maleic-anhydride-modified olefin copolymers and/or mixtures thereof are preferred as impact modifiers.

14. A polyamide molding material according to claim 1, characterized in that the further additive and/or the further addition agent (f) is contained in the polyamide molding material with 0.1 to 15% by weight, preferably 0.2 to 10% by weight, and more preferably 0.25 to 5% by weight.

15. A polyamide molded body which consists at least in sections of a polyamide molding material according to claim 1, preferably provided in form of components which require electrical conductivity, for interior and exterior parts in the automotive sector and in the region of other means of transport, preferably for filler cap covers, in the electric and electronic sector, especially for parts of a housing or housing component for portable electronic devices, domestic appliances, domestic machines, devices and apparatuses for telecommunications and consumer electronics, preferably mobile phones, interior and exterior parts with preferably supporting mechanical function with electrical conductivity in the areas of electricity, furniture, sports, mechanical engineering, sanitation and hygiene, medicine, energy and drive technology.

16. The use of particulate mineral or saline fillers for reducing the specific surface resistance and/or the specific volume resistance of carbon-fiber-containing polyamide molding materials with a carbon-fiber diameter in the range of 2 to 10 μm.
